(19) United States
(12) Patent Application Publication
(10) Pub. No.: US 2008/0215183 A1
(43) Pub. Date: Sep. 4, 2008

(54) Interactive Entertainment Robot and Method of Controlling the Same

(76) Inventors: Ying-Tsai Chen, Taipei County (TW); Tai-Wei Lin, I-Lan City (TW); Hung-Yi Chen, Hsin-Chu City (TW); Wei-Nan William Tseng, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/037,941

(22) Filed: Feb. 27, 2008

(30) Foreign Application Priority Data
Mar. 1, 2007 (TW) 096107005

(51) Int. Cl. G06F 17/00

(52) U.S. Cl. 700/245; 901/1

(57) ABSTRACT

A entertainment robot includes a recognition unit, an environment detecting unit, an intelligent unit, and a behavior unit. The recognition unit receives an input signal from a user and outputs a corresponding command signal. The environment detecting unit detects background information and outputs a corresponding environment signal. The intelligent unit outputs a corresponding behavior signal based on the command signal and the environment signal. The behavior unit controls the operation of the entertainment robot based on the behavior signal.

### BACKGROUND OF THE INVENTION

1. Field of the Invention

The present invention is related to an interactive home entertainment robot, especially an interactive entertainment robot that plays songs and behaves according to a user's command and a background environment.

2. Description of the Prior Art

According to the categorization set forth by International Federation of Robotics (IFR) and United Nations Economic Commission for Europe (UNECE), robots can be categorized to two kinds, Industrial Robots and Service Robots.

Service Robots can be further categorized to Professional Use and Personal/Home Use. Professional Use robots can be applied to military uses (such as mine sensing robots, anti-terrorism explosion proof robots, mini surveillance robots, etc.), agriculture uses (such as lumbering robots, fruit picking robots, etc.), or medical uses (such as laser therapy robots, operation assisting robots, wheelchair robots, etc.). Personal/Home Use robots can be applied to domestic chores (such as vacuuming robots, lawn mowing robots, swimming pool cleaning robots, etc.), entertainment (such as toy robots, education and training robots, etc.), or household affairs (such as home security robots, monitoring robots, etc.). There is a great variety of Service Robots applied in various aspects, and will be a future trend in the robot industry.

Service Robots are becoming common lately, wherein the interactive home entertainment robots come closest to the user's daily life. Comparing to automatic industrial robots, the interactive home entertainment robots must interact with family members for entertaining people.

### SUMMARY OF THE INVENTION

It is therefore a primary objective of the claimed invention to provide an interactive entertainment robot that plays songs and behaves according to a user's command and a background environment.

The present invention discloses an interactive entertainment robot, which comprises a recognition apparatus for receiving an input signal from a user, and outputting a corresponding command signal, an environment detecting apparatus for detecting environment information of the environment the robot is in, and outputting a corresponding environment signal, an intelligence apparatus for outputting a behavior signal based on the command signal and the environment signal, and a behavior apparatus for controlling operations based on the behavior signal.

The present invention further discloses a method for controlling a robot, which comprises the following steps: generating a command signal according to a command of a user, detecting a background information for generating a corresponding environment signal, generating a behavior signal based on the command signal and the environment signal, and controlling the robot to take action based on the behavior signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a functional diagram of an interactive entertainment robot according to a first embodiment of the present invention.

FIG. 2 illustrates a functional diagram of an interactive entertainment robot according to a second embodiment of the present invention.

FIG. 3 is a flowchart of a process according to an embodiment of the present invention.

### DETAILED DESCRIPTION

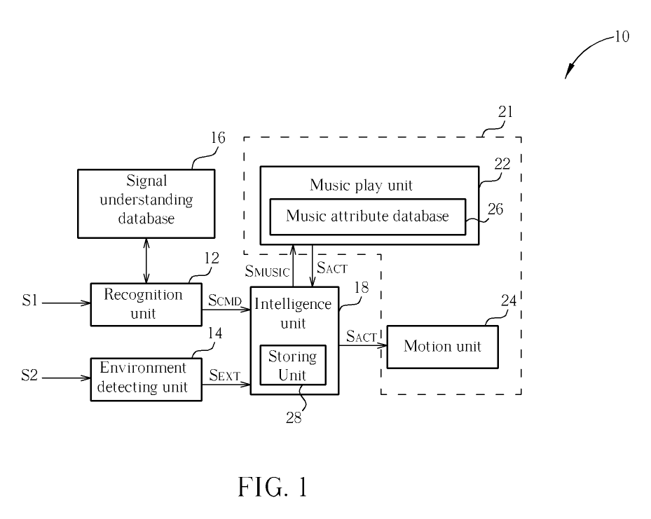

Please refer to FIG. 1, which illustrates a functional diagram of an interactive home entertainment robot 10 according to a first embodiment of the present invention. The interactive home entertainment robot 10 comprises a recognition unit 12, an environment detecting unit 14, a signal understanding database 16, an intelligence unit 18 and a behavior apparatus 21 including a music play unit 22 and a motion unit 24. The interactive home entertainment robot 10 controls the music play unit 22 and the motion unit 24 based on input signals S1 and S2, so as to play corresponding music and execute related actions.

The recognition unit 12 can receive the input signal S1 corresponding to a command from the user or a controller. The input signal S1 can be voice signals sent from the user, or infrared or electronic signals sent from a controller. Since users speak in different ways, a command of a specified meaning can be given through different voice commands. For example, to play a birthday song, a user can say “Let's have a birthday song.”, “Play a birthday song.”, or “Sing a birthday song.”, and the interactive home entertainment robot 10 must be able to recognize the meaning of the input signal S1, so as to execute the command sent from the user correctly. In the first embodiment of the present invention, data related to the commands and meaning thereof is stored in a signal understanding database 16. After receiving the input signal S1, the recognition unit 12 processes the input signal S1 and reads data from the signal understanding database 16 correspondingly, so as to recognize the meaning of the input signal S1. In addition, the recognition unit 12 outputs a command signal S_{CMD} to the intelligence unit 18 and the command signal S_{CMD} is generated based on the input signal S1 and related data stored in the signal understanding database 16. The environment detecting unit 14 can detect the input signal S2 related to background parameters, while the input signal S2 can be sound signals, light signals or other signals in the background. For instance, the environment detecting unit 14 includes a sound detector, a brightness detector, and a population detector, for sensing sound volume, brightness, and an population in the background, and generating an environment signal S_{EXT} accordingly. Therefore, the intelligence unit 18 can determine the background condition based on the environment signal S_{EXT}.

The music play unit 22 and the motion unit 24 are used for controlling the behavior of the interactive home entertainment robot 10 according to behavior signals including a control signal S_{MUSIC} and an action signal S_{ACT}. The control signal S_{MUSIC} includes music attribute information, and the intelligence unit 18 includes a storing unit 28 for storing the music attribute information. The music attribute information contains an identification attribute and a feature attribute. The identification attribute comprises “song name”, “artist”, “album”, “category”, etc., which are basic information of a song, and can be provided from a tag of the song. The feature attribute comprises “language”, “rankings”, “environment”, “Playlist”, “assigned action”, etc, which can be set by users or through other methods. For example, the “language” of a Spanish song is set as “Spanish” or “Latin”. “Rankings” can show how much the user likes the song. “Environment” explains the appropriate condition to play the song. “Playlist” shows a song list including the song. “Assigned action” is assigned action attribute data of the song, indicating the related behaviors of the interactive home entertainment robot 10 when the song is played. Usually, a song playing command send from the user points out the music attributes, such as “Play the birthday song”, “Play songs in album A”, “Play English songs by B artist”, etc.

The music play unit 22 includes a music attribute database 26 and the music attribute database 26 stores a plurality of songs with music attribute data individually. Preferably, the music attribute data is categorized into the same attributes as those of the music attribute information, such as “song name”, “artist”, “album”, “category”, “language”, “rankings”, “environment”, “Playlist”, “assigned action”, etc. The music play unit 22 plays a song of the plurality of songs when the music attribute data of the song is found in conformity with the music attribute information of the control signal S_{MUSIC}.

In the first embodiment of the present invention, based on the command signal S_{CMD} and the environment signal S_{EXT}, the intelligence unit 18 outputs a control signal S_{MUSIC} for controlling the music play unit 22. In addition, the music play unit 22 outputs an action signal S_{ACT}, including assigned action attribute information, to the intelligence unit 18. The action signal S_{ACT} is processed by the intelligence unit 18 and then outputted for controlling the motion unit 24. The motion unit 24 controls the interactive home entertainment robot 10 to perform actions according to the assigned action attribute data. In this way, the music played by the interactive home entertainment robot 10 matches the command from the user and the background, and thereby related actions are carried out. For example, lovers tend to celebrate birthdays in a dim and quiet environment. When the user phonetically gives the command “let's have a birthday song”, the recognition unit 12 processes the phonetic signal and reads the signal understanding unit 16 accordingly. After identifying the meaning of “let's have a birthday song”, the recognition unit 12 sends a corresponding command signal S_{CMD} to the intelligence unit 18, and therefore the intelligence unit 18 learns that the user wants the interactive home entertainment robot 10 to play a birthday song. Meanwhile, the environment detecting unit 14 detects background parameters, and outputs the environment signal S_{EXT} to notify the intelligent unit 18 of background information of “low volume”, “low brightness”, and “two people”. Based on the command signal S_{CMD} and the environment signal S_{EXT}, the intelligent unit 18 can determine that the song mostly appropriate to the current condition is a romantic birthday song, and send the corresponding control signal S_{MUSIC} to the music play unit 22. Then the music play unit 22 searches the music attribute database 26 for songs having the music attribute data matching the music attribute information of the control signal S_{MUSIC}. For example, the music play unit 22 search the “song name” containing the keyword “birthday” and also the “environment” corresponding to “romantic”, and then set the “playlist” attribute of the song to generate a playlist whose songs match the music attribute information, so that the music play unit 22 can play songs according to the playlist on demand. At the same time, the music play unit 22 outputs a corresponding action signal S_{ACT} to the intelligent unit 18 according to the “assigned action” of each song in the playlist, and the intelligent unit 18 controls the motion unit 24 based on the action signal S_{ACT}. Hence, the music play unit 22 can play songs on the playlist, and meanwhile the motion unit 24 can control the interactive home entertainment robot 10 to carry out the actions corresponding to the playing song.

Taking another example, a birthday party (suppose 20 people) usually has a bright and noisy background. When the user gives the command “let's have a birthday song” phonetically, the recognition unit 12 processes the received phonetic signal and reads the signal understanding database 16 accordingly. After identifying the meaning of “let's have a birthday song”, the recognition unit 12 sends a corresponding command signal S_{CMD} to the intelligence unit 18, and therefore the intelligence unit 18 learns that the user wants the interactive home entertainment robot 10 to play a birthday song. Meanwhile, the environment detecting unit 14 detects the background parameters, and sends the environment signals S_{EXT} corresponding to “high volume”, “high brightness”, and “20 people” to the intelligent unit 18. Based on the command signal S_{CMD} and the environment signal S_{EXT}, the intelligent unit 18 can determine that a happier and party-like birthday song is more appropriate to be played under the current condition, and send the corresponding control signal S_{MUSIC} to the music play unit 22. Then, the music play unit 22 searches the music attribute database 26 for songs having the music attribute data matching the music attribute information of the control signal S_{MUSIC}. For example, the music play unit 22 searches the “song name” containing the keyword “birthday”, and the “environment” corresponding to “happy” or “party”, and then sets the “playlist ” attribute of the song to generate a playlist whose songs match the control signal S_{MUSIC}, so that the music play unit 22 can play the song of the user's demand based on the playlist. At the same time, the music play unit 22 outputs a corresponding action signal S_{ACT} to the intelligent unit 18 according to the “assigned action” of each song in the playlist, and the intelligent unit 18 controls the control motion unit 24 with the action signal S_{ACT}. Hence, the music play unit 22 can play songs on the playlist, and meantime the motion unit 24 can control the interactive home entertainment robot 10 to carry out the actions corresponding to the playing song.

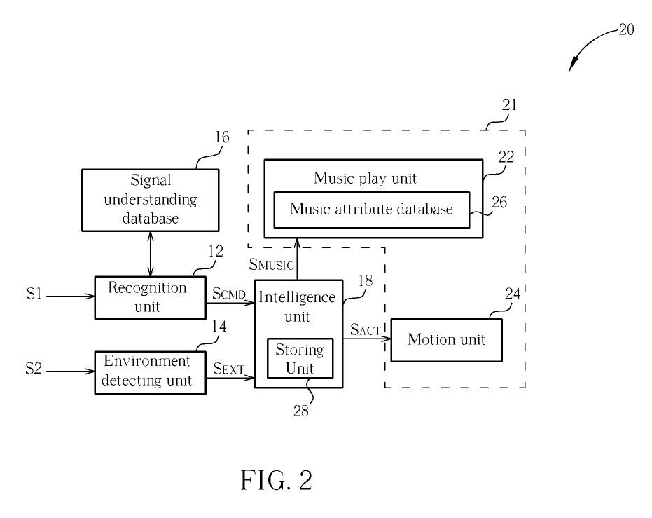

Please refer to FIG. 2, illustrating a schematic diagram of an interactive home entertainment robot 20 according to a second embodiment of the present invention. The interactive home entertainment robot 20 also comprises a recognition unit 12, an environment detecting unit 14, a signal recognition database 16, an intelligent unit 18, a music play unit 22, and a motion unit 24. The interactive home entertainment robot 20 of the second embodiment of the present invention is similar to the interactive home entertainment robot 10 of the first embodiment of the present invention in structure, and can also control the music play unit 22 and the motion unit 24 based on two input signals S1 and S2, so as to play music correspondingly and take related actions. Nevertheless, in the second embodiment of the present invention, based on a command signal S_{CMD} and an environment signal S_{EXT}, the intelligent unit 18 generates a control signal S_{MUSIC} for controlling the music play unit 22 and an action signal S_{ACT} for controlling the motion unit 24, for the interactive home entertainment robot 20 to play the music matching the command from the user and the background, and carry out related actions at the same time.

For example, having two lovers celebrating a birthday, when the user phonetically gives the command “let's have a birthday song”, the recognition unit 12 sends a corresponding command signal S_{CMD} to the intelligent unit 18, and the environment detecting unit 14 sends an environment signal S_{EXT} of “low volume”, “low brightness”, and “two people” to the intelligent unit 18. Based on the command signal S_{CMD} and the environment signal S_{EXT}, the intelligent unit 18 can determine that a romantic birthday song is more appropriate to be played under the current condition, and send the corresponding control signal S_{MUSIC} and action signal S_{ACT} to the music playing unit 22 and the motion unit 24. Therefore, the music play unit 22 can play a romantic birthday song based on the control signal S_{MUSIC}, and the motion unit 24 can carry out actions corresponding to “birthday” and “romantic” based on the action signal S_{ACT}. Meantime, when the user gives a “let's have a birthday song” command in a 20-people birthday party phonetically, the recognition unit 12 sends the corresponding command signal S_{CMD} to the intelligent unit 18, and the environment detecting unit 14 sends an environment signal S_{EXT} corresponding to “high volume”, “high brightness”, and “20 people” to the intelligent unit 18. Based on the command signal S_{CMD} and the environment signal S_{EXT}, the intelligent unit 18 can determine that a happier and party-like birthday song is more appropriate to be played under the current condition, and send the corresponding control signal S_{MUSIC} and action signal S_{ACT} to the music playing unit 22 and the motion unit 24. Therefore, the music play unit 22 can play a happier and party-like birthday song based on the control signal S_{MUSIC}, and the motion unit 24 can carry out actions corresponding to “birthday”, “happy” or “party” based on the action signal S_{ACT}.

In the present invention, the intelligent unit 18 can analyze the command signal S_{CMD} and the environment signal S_{EXT}, and save the analyzed results in the storing unit 28. In this way, the intelligent unit 18 can save song playing records and personal song preferences, so that when the user gives an unclear play command, the music play unit 22 can also generate the control signal S_{MUSIC} for controlling the music play unit 22 based on previous playing records. For example, when the user gives a “play song” command, the music play unit 22 can check previous playing records of the user, and play the most often played song by the user.

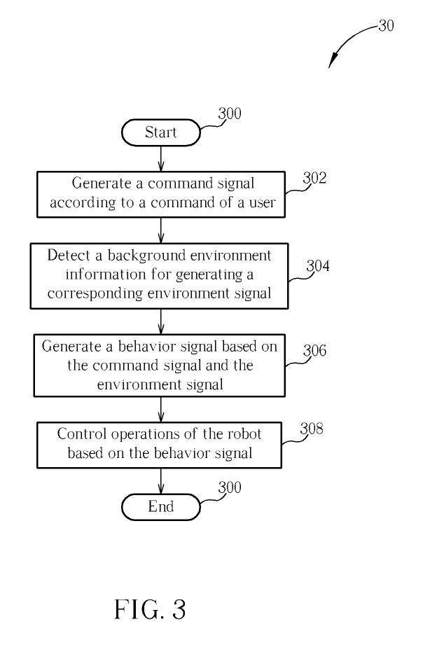

Please refer to FIG. 3, which is a flowchart of a process 30 according to an embodiment of the present invention. The process 30 can be used for controlling the interactive home entertainment robots 10 and 20 and includes the following steps:

Step 300: Start.

Step 302: Generate a command signal according to a command of a user.

Step 304: Detect a background environment information for generating a corresponding environment signal;

Step 306: Generate a behavior signal based on the command signal and the environment signal; and

Step 308: Control operations of the robot based on the behavior signal.

Step 310: End.

According to the process 30, the command signal in Step 302 can be generated by receiving voice signals from the user or infrared signals or electronic signals provided by the user though a controller. The detected background environment information in Step 304 may be volume, brightness, or a population in the background environment. The behavior signal preferably includes the abovementioned control signal S_{MUSIC} and the action signal S_{ACT}, which include the music attribute information and the assigned action attribute information, respectively. The operations of the robot preferably include music-oriented and action-oriented operations, and are performed based on the control signal S_{MUSIC} and the action signal S_{ACT}. Detailed description of the process 30 can be referred by the detailed description of the interactive home entertainment robots 10 and 20, and therefore is omitted here.

In the present invention, the user can play songs by different methods without explicitly pointing out the song name. The interactive home entertainment robot of the present invention can play songs based on the user's previous song playing records. Furthermore, the interactive home entertainment robot of the present invention can play songs and carry out actions based on the command from the user and the background environment at the same time, and therefore can have a more vivid interaction with the user.

Those skilled in the art will readily observe that numerous modifications and alterations of the device and method may be made while retaining the teachings of the invention.

What is claimed is:

1. An interactive entertainment robot comprising:
a recognition unit for receiving an input signal, and outputting a corresponding command signal;
an environment detecting unit for detecting environment information of the environment surrounding the robot, and outputting a corresponding environment signal;
an intelligence unit for outputting a behavior signal based on the command signal and the environment signal; and
a behavior apparatus for controlling operations of the robot based on the behavior signal.

2. The robot of claim 1, wherein the behavior apparatus comprises a music play unit and the behavior signal comprises a control signal with music attribute information, the music play unit playing music based on the control signal.

3. The robot of claim 2, wherein the intelligence unit further comprises a storing unit for storing the music attribute information.

4. The robot of claim 2, wherein the music play unit comprises a music attribute database for storing a plurality of songs with music attribute data individually.

5. The robot of claim 4, wherein the music play unit plays a song of the plurality of songs when the music attribute data of the song is in conformity with the music attribute information of the control signal.

6. The robot of claim 5, wherein the music attribute data comprises a song name, an artist, an album, a category, language, rankings, environment, a play list and an assigned action.

7. The robot of claim 5, wherein the song comprises an assigned action attribute data, and the music play unit outputs an action signal with the assigned action attribute data to the intelligence unit.

8. The robot of claim 7, wherein the behavior apparatus further comprises a motion unit for controlling actions of the robot according to the action signal from the intelligence unit.

9. The robot of claim 2, wherein the behavior signal further comprises an action signal with assigned action attribute information.

10. The robot of claim 9, wherein the behavior apparatus further comprises:
a motion unit for controlling actions of the robot based on the action signal.

11. The robot of claim 2, wherein the music attribute information comprises an identification attribute and a feature attribute.

12. The robot of claim 11, wherein the identification attribute comprises a song name, an artist, an album and a category.

13. The robot of claim 11, wherein the feature attribute comprises attributes corresponding to language, rankings, environment, a play list and an assigned action.

14. The robot of claim 1 further comprising:
a signal understanding database for storing data related to the input signal, the recognition unit outputting the command signal based on the data.

15. A method for controlling a robot comprises the following steps:
(a) generating a command signal according to a command of a user;
(b) detecting a background environment information for generating a corresponding environment signal;
(c) generating a behavior signal based on the command signal and the environment signal; and
(d) controlling operations of the robot based on the behavior signal.

16. The method of claim 15, wherein step (a) is receiving voice signals from the user.

17. The method of claim 15, wherein step (a) is receiving infrared signals or electronic signals provided by the user though a controller.

18. The method of claim 15, wherein step (b) is detecting volume, brightness, or a population in the background environment.

19. The method of claim 15 further comprising:
storing a plurality of songs with music attribute data individually.

20. The method of claim 19 further comprising:
searching a song having the music attribute data in conformity with music attribute information of the behavior signal.

21. The method of claim 20 further comprising:
outputting an action signal with assigned action attribute data corresponding to the song.

22. The method of claim 21, wherein step (d) is playing the song and performing the assigned action based on the behavior signal and the action signal.
